(19) United States
(12) Patent Application Publication
(10) Pub. No.: US 2016/0061378 A1
(43) Pub. Date: Mar. 3, 2016

(54) HOIST

(71) Applicant: Ricky G. Marchant, Guthrie, OK (US)

(72) Inventor: Ricky G. Marchant, Guthrie, OK (US)

(21) Appl. No.: 14/843,283

(22) Filed: Sep. 2, 2015

Related U.S. Application Data
(60) Provisional application No. 62/045,345, filed on Sep. 3, 2014.

(51) Int. Cl. F16M 11/18; F16M 11/04; A01K 5/00; F16M 11/22

(52) U.S. Cl. CPC F16M 11/18; F16M 11/22; F16M 11/046; A01K 5/00

(57) ABSTRACT

An apparatus and method for supporting an object in an elevated position relative to a ground surface. The apparatus includes a tubular support member, a housing connected to the tubular support member, a winch supported in the housing, and a cable connected to the winch and extending from the winch through the housing and through the tubular support member in a way that the cable is concealed from unauthorized tampering. The apparatus may also include a first, second, and third roller for guiding the cable and a hook for securing an object to the tubular support member.

### CROSS REFERENCE TO RELATED APPLICATIONS

This application claims priority to U.S. Provisional Application Ser. No. 62/045,345, filed on Sep. 3, 2014, the entirety of which being hereby expressly incorporated herein by reference.

### BACKGROUND

For years, hunters have used feeders for periodically distributing feed to animals to supplement their diets and to attract a higher concentration of animals to a particular area. Such feeders are typically supported well above ground level and well above the height of the animals so that the feeders are not destroyed by the animals attempting to remove the feed and so that the feeders are not readily accessible to thieves.

Support systems for feeders come in a variety of forms including suspending a feeder from a tree and tripod stands. Other support systems utilize a hoist cable and a heavy duty winch. Unauthorized tampering of feeders supported by these types of systems is a common problem. The tripod stands are susceptible to being tipped over by animals and humans attempting to remove the feed or steal the feeder, and winch systems are susceptible to theft because a thieve can lower the feeder using the winch or cut the cable to release the feeder form its elevated position.

Thus, a need exists for a support system that is stable and that is able to support a variety of objects in an elevated position while preventing unauthorized tampering with the same. It is to such an apparatus that the inventive concepts disclosed herein are directed.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale, or in schematic in the interest of clarity and conciseness. Not every component may be labeled in every drawing. Like reference numerals in the figures may represent and refer to the same or similar element or function. In the drawings:

FIG. 1 is a front elevational view of a hoist constructed in accordance with the inventive concepts disclosed herein.

FIG. 2 is a cross-sectional view of the hoist of FIG. 1.

FIG. 3 is a cross-sectional view taken along the 3-3 line of FIG. 2.

FIG. 4 a perspective view of a hook of the hoist of FIG. 1.

### DETAILED DESCRIPTION OF EXEMPLARY EMBODIMENTS

Before explaining at least one embodiment of the presently disclosed and claimed inventive concepts in detail, it is to be understood that the presently disclosed and claimed inventive concepts are not limited in their application to the details of construction, experiments, exemplary data, and/or the arrangement of the components set forth in the following description or illustrated in the drawings. The presently disclosed and claimed inventive concepts are capable of other embodiments or of being practiced or carried out in various ways. Also, it is to be understood that the phraseology and terminology employed herein is for purpose of description and should not be regarded as limiting.

In the following detailed description of embodiments of the inventive concepts, numerous specific details are set forth in order to provide a more thorough understanding of the inventive concepts. However, it will be apparent to one of ordinary skill in the art that the inventive concepts disclosed and claimed herein may be practiced without these specific details. In other instances, well-known features have not been described in detail to avoid unnecessarily complicating the instant disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements or steps is not necessarily limited to only those elements or steps and may include other elements, steps, or features not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Throughout this disclosure and the claims, the terms “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, or combinations thereof, for example.

The use of the term “at least one” will be understood to include one as well as any quantity more than one, including but not limited to each of, 2, 3, 4, 5, 10, 15, 20, 30, 40, 50, 100, and all integers therebetween. The term “at least one” may extend up to 100 or 1000 or more, depending on the term to which it is attached; in addition, the quantities of 100/1000 are not to be considered limiting, as higher limits may also produce satisfactory results. Singular terms shall include pluralities and plural terms shall include the singular unless indicated otherwise.

The term “or combinations thereof” as used herein refers to all permutations and/or combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment, although the inventive concepts disclosed herein are intended to encompass all combinations and permutations including one or more of the features of the embodiments described herein.

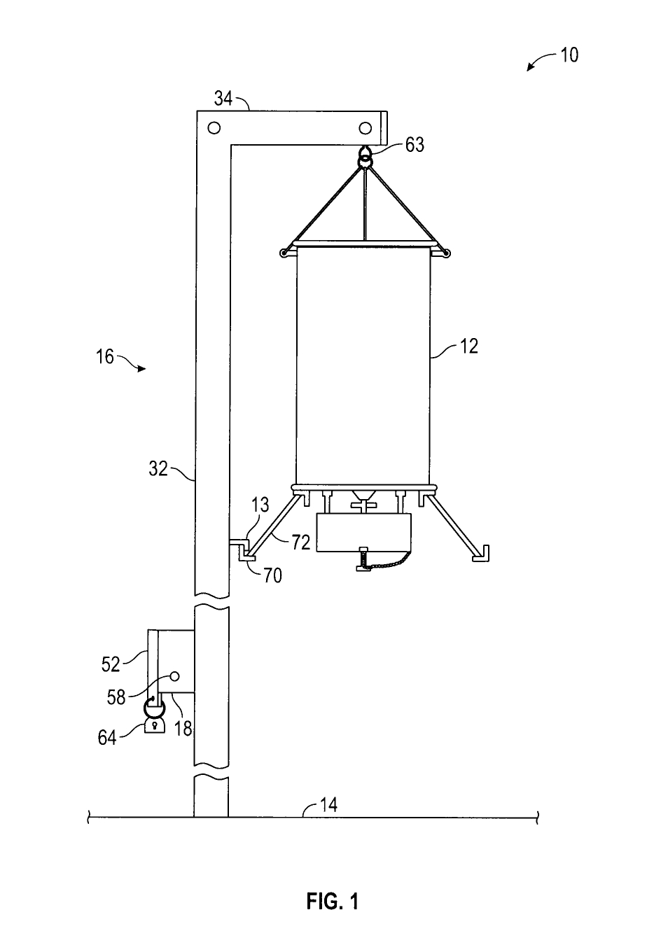

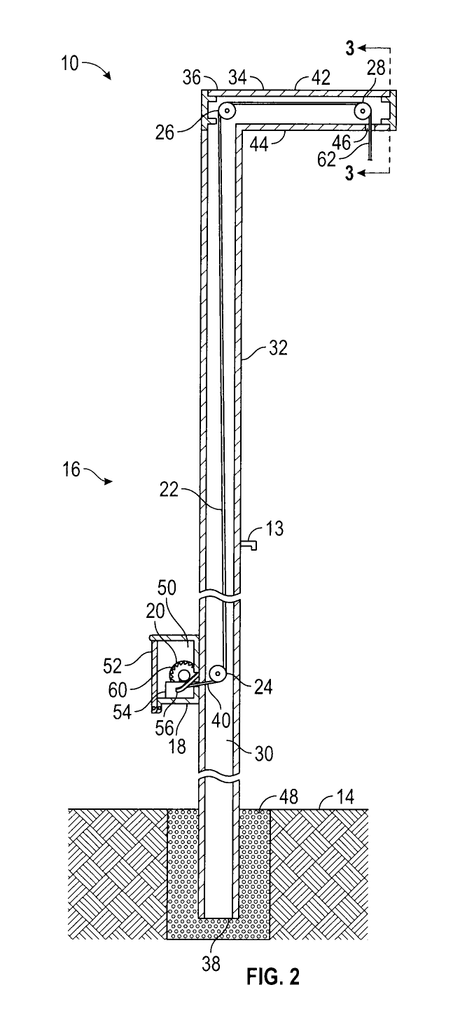

Referring now to FIGS. 1 and 2, a hoist 10 for supporting an object, such as a feeder 12, in an elevated position, is illustrated. The feeder 12 is in an elevated position relative to a ground surface 14. The hoist 10 is constructed so that the feeder 12 may be lowered to fill the feeder 12 with feed and raised to an elevated feeding and storage position. When in the elevated position, the feeder 12 is well above the height of an average person so as to prevent unauthorized tampering by humans or destruction by animals. Additional features described below further prevent the feeder 12 from unauthorized tampering. It should be appreciated that the hoist 10 may be used for supporting and storing other objects (including but not limited to boats and bicycles) in an elevated position and preventing unauthorized tampering of the same.

The hoist 10 includes a tubular support member 16, a housing 18 connected to the tubular support member 16, a winch 20 supported in the housing 18, and a cable 22 connected to the winch 20 and extending from the winch 20 through the housing 18 and through the tubular support member 16. As described below, the hoist 10 may also include a first roller 24, a second roller 26, and a third roller 28 for guiding the cable and a hook 13 for securing on object, such as the feeder 12, to the hoist 10.

The tubular support member 16 defines a passage 30 through which the cable 22 runs in a concealed manner. The tubular support member 16 includes a vertical portion 32 and a horizontal portion 34 extending from vertical portion 32 in a substantially perpendicular relationship. The vertical portion 32 has an upper end 36, a lower end 38, and an inlet 40 into the passage 30. The inlet 40, which is sized to receive the cable 22, is positioned between the upper end 36 and the lower end 38, which is embeddable in the ground. In one embodiment, the vertical portion 32 may be embedded approximately four feet below the ground surface 14 and is supported by a volume of concrete 48 surrounding the vertical portion 16 that is below the ground surface 14. The volume of concrete 48 stabilizes the tubular support member 16 and prevents it from being tipped over by an animal or human attempting to access the feeder 12 or other hoisted object.

The horizontal portion 34 extends from the upper end 36 of the vertical portion 32 and includes an upper side 42, a lower side 44, and an outlet 46 from the passage 30 formed through the lower side 44 of the horizontal portion 34. The outlet 46 is substantially the same size as the inlet 22.

The tubular support member 16 may be formed of a variety of shapes including but not limited to cylindrical, polygonal, or square. In at least one embodiment, the vertical portion 32 and the horizontal portion 34 each have four side walls forming a square. The vertical portion 32 and horizontal portion 34 of the tubular support member 16 may also be formed of a variety of sizes. The lengths of each may vary, and the widths of each may be varied, but will generally be substantially the same. For example, in one embodiment, the vertical portion 32 and the horizontal portion 34 may be formed 2 inch×3 inch steel. The length of the vertical portion 32 may be, but is not limited to being between about 12 feet by about 20 feet. Specifically, in at least one embodiment, the length of the vertical portion 32 may be about 16 feet. The length of the horizontal portion 34 may be, but is not limited to being, between about 18 inches and about 24 inches. Specifically, in at least one embodiment, the length of the horizontal portion 34 may be about 18 inches or half of the width of the object to be suspended. The tubular support member 18 may be formed of a variety of materials such as stainless or galvanized steel and by extrusion, piercing, welding, or other known processes, or may be formed of rigid plastic and by extrusion, injection, or other known processes. It will be appreciated that the tubular support member 16 may be formed as one piece, or from multiple sections to facilitate transport.

The housing 18 is connected to the vertical portion 32 of the tubular support member 16 so as to be positioned over the inlet 40 of the vertical portion 32. The housing 18 defines a cavity 50 for supporting the winch 20 and includes a door 52 for providing selective access to the cavity 50. The winch 20 may have a body and a handle detachably connected to the body, such as body 54 and handle 56 (shown in FIG. 2). The housing 18 may have an opening, such as opening 58 (shown in FIG. 1), through which the handle 56 of the winch 20 extends when the handle 56 is connected to the body 56.

The housing 18 may be formed of a variety of shapes including but not limited to rectangular and square and may be formed of a variety of sizes so long as the housing 18 is sized to support the winch 20. Specifically, in at least one embodiment, the housing 18 may have four side walls forming a rectangle. The housing 18 may be formed of the any suitable material as the tubular support member, including but not limited to plastics and steel. Any suitable winch may be used depending on the weight of the object being supported by the hoist 10. For example, a suitable winch may include Torin® Big Red Jacks 600 pound hand winch with a gear ratio of 3.1:1, a drum hub diameter of ⅝ inches, and a handle length of 6½ inches.

When the feeder 12 is in a fully elevated position, the cable 22 is concealed. The cable 22 includes a first end 60 and a second end 62. The first end 60 is connected to the winch 20 and extends from the winch 20 through the cavity 50 of the housing 18, through the inlet 40 of the vertical portion 32, through the passage 30 of the tubular support member 16, and through outlet 46 of the horizontal portion 34 in a way that the portion of the cable 22 positioned between the winch 20 and the outlet 46 is concealed and protected from unauthorized tampering. The cable 22 terminates in a hook 63 (FIG. 1) for attaching the cable 22 to an object, such as the feeder 12.

In at least one embodiment, the housing 18 and the door 52 are constructed to receive a lock, such as lock 64 (FIG. 1), for securing the door 52 to the housing 18 so as to limit access to the winch 20 and the cable 22. In this way, only a person with a key to the lock can access the winch 20 and the cable 22. Limiting access to the winch 20 and the cable 22 reduces the chances that an unauthorized person, such as a trespasser, may remove and steal the feeder 12. Because the cable 22 is concealed between winch 20 and the outlet 46, an unauthorized person cannot cut the cable 22 to remove the feeder 12 or any other object connected to the second end 62 of the cable 22 and supported by the hoist 10.

As shown in FIG. 2, in some embodiments, the hoist 10 is provided with three rollers, such as first roller 24, second roller 26, and third roller 28. The first roller 24 is supported in the passage 30 adjacent to the inlet 40 of the vertical portion 32. As such, the first roller 24 is in substantial horizontal alignment with the winch 20, to which the first end 60 of the cable 22 is connected, and the cable 22 runs from the winch 20 to the first roller 24. The second roller 26 is supported in the passage 30 at the intersection of the horizontal portion 34 and the vertical portion 32. The cable 22 runs from the first roller 24 to the second roller 26. The third roller 28 is supported in the passage 30 adjacent to the outlet 46 of the horizontal portion 34. The cable 22 runs from the second roller 26 to the third roller 28. The winch 20, the first, second, and third rollers 24/26/28 guide the cable 22 from the cavity 50 of the housing 18 and through the passage 30 of the tubular support member 16.

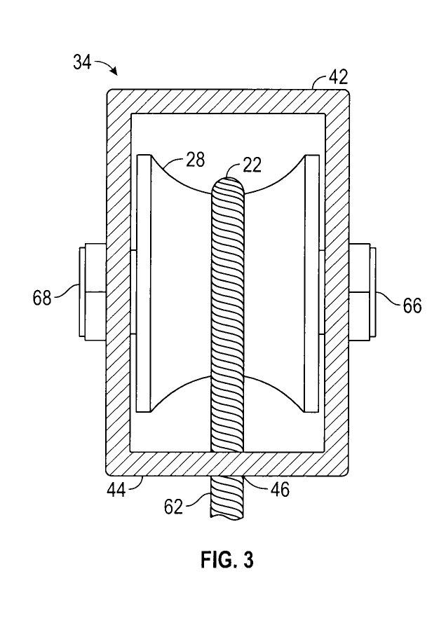

In some embodiments, the first, second, and third rollers 24/26/28 span substantially the width of the passage 30 so that the cable 22 is less likely to lose contact with any one of the rollers. Each roller 24/26/28 may be supported in the passage 30 by a bolt and nut, such as bolt 66 and nut 68 of FIG. 3. The first, second, and third rollers 24/26/28 are substantially the same size and shape. Each roller is formed of a cylindrical, concave shape. The diameter of each roller will depend on the width of the passage. Each roller 24/26/28 may also be formed of the same materials including but not limited to steel and aluminum.

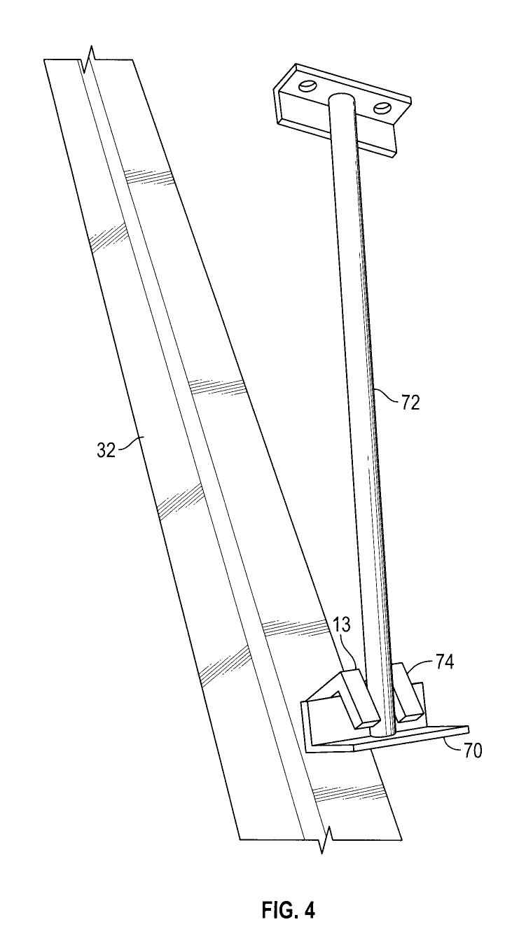

The tubular support member 16 of the hoist 10 may also include a hook 13 (shown in FIGS. 1, 2, and 4) extending from the vertical portion 32 for securing an object, such as feeder 12, to the tubular support member 16 when the feeder 12 is connected to the hook 63 of the second end 62 of the cable 22. The hook 13 is constructed to receive a foot 70 of a leg 72 (shown in FIGS. 1 and 4) of the feeder 12. The hook includes a pair of teeth 74 that extend to either side of the leg 72 and secure the foot 70. This prevents the feeder 12 from colliding with the tubular support member 16 and keeps the feeder 12 in a stable position while dispensing feed.

From the above description, it is clear that the present inventive concept is well adapted to carry out the objects and to attain the advantages mentioned herein as well as those inherent in the invention. While exemplary embodiments of the invention have been described for purposes of this disclosure, it will be understood that numerous changes may be made which will readily suggest themselves to those skilled in the art and which are accomplished within the spirit of the inventive concept disclosed and claimed herein.

What is claimed is:

1. An apparatus for supporting an object in an elevated position relative to a ground surface, comprising:
a tubular support member defining a passage and having a vertical portion and a horizontal portion, the vertical portion having an upper end, a lower end, and an inlet into the passage positioned between the upper end and the lower end, the lower end being embeddable in the ground, the horizontal portion extending from the upper end of the vertical portion in a substantially perpendicular relationship to the vertical portion and having an upper side, a lower side, and an outlet from the passage formed through the lower side of the horizontal portion;
a housing defining a cavity and connected to the vertical portion of the tubular support member so as to be positioned over the inlet of the vertical portion, the housing having a door for providing selective access to the cavity of the housing;
a winch supported in the cavity of the housing; and
a cable having a first end and a second end, the first end connected to the winch, the cable extending from the winch and through the cavity of the housing, the inlet of the vertical portion, the passage of the tubular support member, and the outlet of the horizontal portion in a way that the portion of the cable positioned between the winch and the outlet is concealed from unauthorized tampering.

2. The apparatus of claim 1, further comprising:
a first roller supported in the passage of the tubular support member adjacent to the inlet of the vertical portion;
a second roller support in the passage of the tubular support member at the intersection of the horizontal portion and the vertical portion; and
a third roller supported in the passage of the tubular support member adjacent to the outlet of the horizontal portion,
wherein the winch and the first, the second, and the third rollers guide the cable from the cavity of the housing and through the passage of the tubular support member.

3. The apparatus of claim 1, wherein the passage has a width and wherein each of the first, the second, and the third rollers span substantially the width of the passage.

4. The apparatus of claim 1, wherein the housing and the door of the housing are constructed to receive a lock for securing the door to the housing so as to limit access to the winch and the cable.

5. The apparatus of claim 1, wherein the winch has a body and handle detachably connected to the body.

6. The apparatus of claim 5, wherein the housing has an opening through which the handle of the winch extends when the handle is connected to the body.

7. The apparatus of claim 1, further comprising a hook extending from the vertical portion of the tubular support member for securing the object to the tubular support member when the object is connected to the second and of the cable.

8. An apparatus in combination with an object for supporting the object in an elevated position relative to a ground surface, comprising:
a tubular support member defining a passage and having a vertical portion and a horizontal portion, the vertical portion having an upper end, a lower end, and an inlet into the passage positioned between the upper end and the lower end, the lower end being embedded in the ground, the horizontal portion extending from the upper end of the vertical portion in a substantially perpendicular relationship to the vertical portion and having an upper side, a lower side, and an outlet from the passage formed through the lower side of the horizontal portion;
a housing defining a cavity and connected to the vertical portion of the tubular support member so as to be positioned over the inlet of the vertical portion, the housing having a door for providing selective access to the cavity of the housing;
a winch supported in the cavity of the housing; and
a cable having a first end and a second end, the first end connected to the winch, the cable extending from the winch and through the cavity of the housing, the inlet of the vertical portion, the passage of the tubular support member, and the outlet of the horizontal portion in a way that the portion of the cable positioned between the winch and the outlet is concealed from unauthorized tampering,
wherein the object is connected to the second end of the cable so that object is positionable between a lowered position and a raised position.

9. The combination of claim 8, further comprising:
a first roller supported in the passage of the tubular support member adjacent to the inlet of the vertical portion;
a second roller supported in the passage of the tubular support member at the intersection of the horizontal portion and the vertical portion; and
a third roller supported in the passage of the tubular support member adjacent to the outlet of the horizontal portion,
wherein the winch and the first, the second, and the third rollers guide the cable from the cavity of the housing and through the passage of the tubular support member.

10. The combination of claim 8, wherein the passage has a width and wherein each of the first, the second, and the third rollers span substantially the width of the passage.

11. The combination of claim 8, wherein the housing and the door of the housing are constructed to receive a lock for securing the door to the housing so as to limit access to the winch and the cable.

12. The combination of claim 8, wherein the winch has a body and handle detachably connected to the body.

13. The combination of claim 12, wherein the housing has an opening through which the handle of the winch extends when the handle is connected to the body.

14. The combination of claim 8, wherein the apparatus further comprises a hook extending from the vertical portion of the tubular support member for securing the object to the tubular support member when the object is in the raised position.

15. The combination of claim 8, wherein the object is an animal feeder.

16. The combination of claim 15, wherein the animal feeder has a leg with a foot, and wherein the apparatus further comprises a hook extending from the vertical portion of the tubular support member for receiving the leg and foot of the animal feeder in a way to secure the animal feeder to the tubular support member when the animal feeder is positioned in the raised position.

17. The combination of claim 16, wherein the cable is concealed entirely when the animal feeder is in the raised position and received in the hook.

18. A method of supporting an object in an elevated position relative to a ground surface, comprising:
obtaining an apparatus comprising:
a tubular support member defining a passage and having a vertical portion and a horizontal portion, the vertical portion having an upper end, a lower end, and an inlet into the passage positioned between the upper end and the lower end, the horizontal portion extending from the upper end of the vertical portion in a substantially perpendicular relationship to the vertical portion and having an upper side, a lower side, and an outlet from the passage formed through the lower side of the horizontal portion;
a housing defining a cavity and connected to the vertical portion of the tubular support member so as to be positioned over the inlet of the vertical portion, the housing having a door for providing selective access to the cavity of the housing;
a winch supported in the cavity of the housing; and
a cable having a first end and a second end, the first end connected to the winch, the cable extending from the winch and through the cavity of the housing, the inlet of the vertical portion, the passage of the tubular support member, and the outlet of the horizontal portion in a way that the portion of the cable positioned between the winch and the outlet is concealed from unauthorized tampering;
embedding a lower end of the tubular support member in the ground;
positioning the second end of the cable in a lowered position;
connecting the object to the second end of the cable; and
operating the winch to move the second end of the cable to a raised position to elevate the object from the ground and conceal an entirety of the cable from unauthorized tampering within the tubular support member and the housing.

19. The method of claim 18, wherein the winch has a body and handle, and wherein the method further comprises detaching the handle from the body when the object is moved to the raised position.

20. The method of claim 18, wherein the object is an animal feeder, wherein the animal feeder has a leg with a foot, and wherein the method further comprises connecting the leg and foot of the animal feeder to a hook extending from the vertical portion of the tubular support member to secure the animal feeder to the tubular support member when the animal feeder is positioned in the raised position.
